(19) United States
(12) Patent Application Publication
(10) Pub. No.: US 2010/0102134 A1
(43) Pub. Date: Apr. 29, 2010

(54) METHOD FOR PRODUCING CODE PATTERNS, AND CODE PATTERNS

(75) Inventors: Cheng-Ru Chang, Hsin-Chu City (TW); Wei-Kuo Mai, Hsin-Chu City (TW)

Correspondence Address: APEX JURIS, PLLC, 12733 LAKE CITY WAY NORTHEAST, SEATTLE, WA, 98125, US

(73) Assignee: ELAN MICROELECTRONICS CORP., Hsin-Chu City (TW)

(21) Appl. No.: 12/350,769

(22) Filed: Jan. 8, 2009

(30) Foreign Application Priority Data
Oct. 24, 2008 (TW) 097140937

(51) Int. Cl. G06K 19/06

(52) U.S. Cl. 235/494

(57) ABSTRACT

A plurality of code patterns including at least two code patterns is provided. The code patterns represent identical information. Adjacent ones of the code patterns of the code patterns meet at an angle. The code patterns at least reduce visual impact.

### FIELD OF THE INVENTION

The present invention relates to code patterns and, more particularly, to code patterns which may reduce visual impact.

### BACKGROUND OF THE INVENTION

Prior art about code pattern and code patterns were disclosed in Japanese Invention Patent Application Publication No. 2007-11890, U.S. Patent Application Publication No. US2007/0246547, Taiwanese Patent Application Publication No. 094205159, U.S. Patent Application Publication No. US2003/011164, and U.S. Patent Application Publication No. US2006/0007255.

Referring to FIG. 1, the above patents taught to produce code patterns repeatedly. Code patterns 1 and 2 comprise a plurality of code patterns A and B, respectively. The code patterns A repeat and represent identical information. The code patterns B repeat and represent another identical information.

To facilitate description, reference numerals shown in FIG. 2 through FIG. 6B indicate positions of information marks in the code patterns.

Referring to FIG. 2, an embodiment of a conventional means of producing code patterns was disclosed in the Japanese Invention Patent Application Publication No. 2007-11890. However, the conventional code patterns shown in FIG. 2 have drawbacks, for example, information marks are likely to be misinterpreted as boundary marks. For instance, if displacement of information marks 1, 2, 3, and 4 is in the same direction, there will be conspicuous horizontal stripes in printed matters; likewise, if displacement of information marks 1, 5, 9, and 13 is in the same direction, there will be conspicuous vertical stripes in printed matters. Hence, as shown in FIG. 2, not only is visual impact on the code patterns great, but information marks approximate to boundary marks in terms of geometrical shape, thereby increasing the likelihood of misinterpretation.

Referring to FIG. 3, another embodiment of a conventional means of producing code patterns was disclosed in U.S. Patent Application Publication No. US2007/0246547. However, the conventional code patterns shown in FIG. 3 have drawbacks, for example, information marks are likely to be misinterpreted as boundary marks. For instance, in the situation where displacement of information marks 2, 4, 5, 6, and 8 is in the same direction, not only do information marks approximate to boundary marks in terms of geometrical shape and thereby increase the likelihood of misinterpretation, but there are conspicuous vertical stripes in printed matters because of the vertical boundary marks therein, thereby compromising the visual effect.

Referring to FIG. 4, yet another embodiment of a conventional means of producing code patterns was disclosed in U.S. Patent Application Publication No. U.S. Ser. No. 60/648,431. However, the conventional code patterns shown in FIG. 4 have drawbacks, for example, information marks are likely to be misinterpreted as positioning marks. For instance, if displacement of information marks 4, 5, 6, and 7 is in the same direction, there will be conspicuous horizontal stripes in printed matters; likewise, if displacement of information marks 2, 5, 9, and 12 is in the same direction, there will be conspicuous vertical stripes in printed matters. Hence, as shown in FIG. 4, not only is visual impact on the code patterns great, but information marks approximate to boundary marks in terms of geometrical shape, thereby increasing the likelihood of misinterpretation.

Referring to FIG. 5A, a further embodiment of a conventional means of producing code patterns was disclosed in U.S. Patent Application Publication No. US2003/011164. FIG. 5B shows an image of an embodiment of the conventional code patterns of FIG. 5A, indicating that the code patterns of FIG. 5B have a drawback, namely great visual impact.

Referring to FIG. 6A, a further embodiment of a conventional means of producing code patterns was disclosed in U.S. Patent Application Publication No. US2006/0007255. FIG. 6B shows an image of an embodiment of an embodiment of the conventional code patterns of FIG. 6A, indicating that the code patterns of FIG. 6B have a drawback, namely great visual impact.

### SUMMARY OF THE INVENTION

It is an objective of the present invention to provide a method for producing a plurality of code patterns so as to enable the code patterns to at least reduce visual impact.

Another objective of the present invention is to provide a plurality of code patterns so as to enable the code patterns to at least reduce visual impact.

The present invention provides a method for producing a plurality of code patterns as recited in claims 1 and 2.

The present invention provides a plurality of code patterns as recited in claim 5.

### BRIEF DESCRIPTION OF THE DRAWINGS

The following illustrative embodiments and accompanying drawings are provided to illustrate these and other advantages, effects, and structural features of the present invention.

FIG. 1 is a schematic view of conventional code patterns;

FIG. 2 is a schematic view of an embodiment of conventional code patterns;

FIG. 3 through FIG. 6C are diagrams showing other embodiments of conventional code patterns;

FIG. 7 is a flow chart of a method for producing a plurality of code patterns according to the present invention;

FIG. 8 is a flow chart of a method for producing a plurality of code patterns according to the present invention;

FIG. 9 is a schematic view a plurality of code patterns according to the present invention;

FIGS. 10 through 14 are schematic views of embodiments of the code patterns for use with the producing method of the present invention, respectively; and

FIGS. 15 through 17 are schematic views of variant embodiments of the code patterns for use with the producing method of the present invention, respectively.

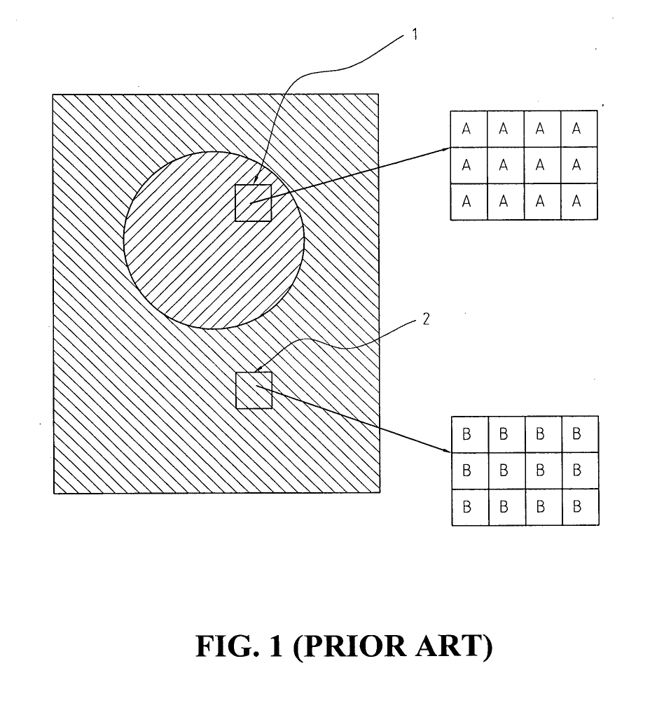

### DETAILED DESCRIPTION OF THE INVENTION

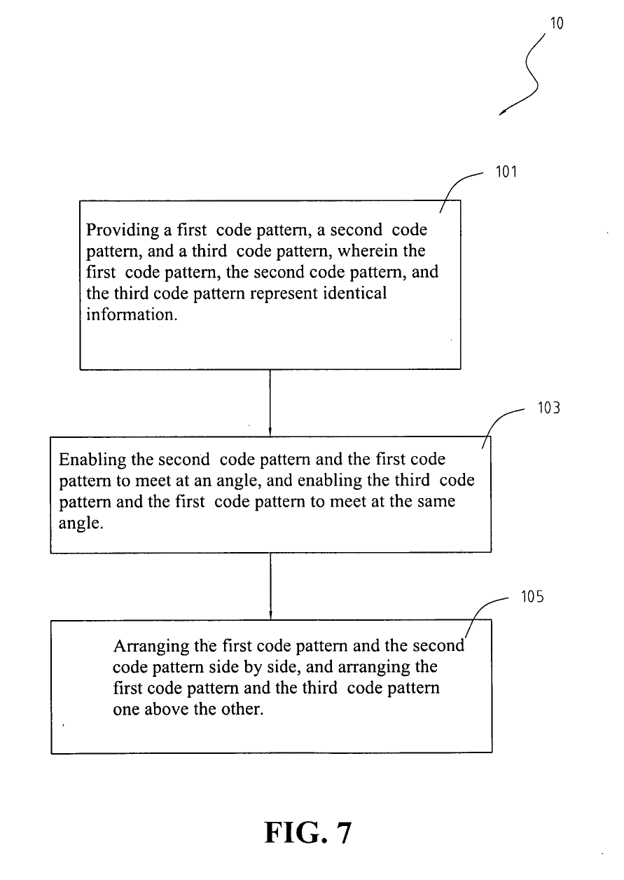

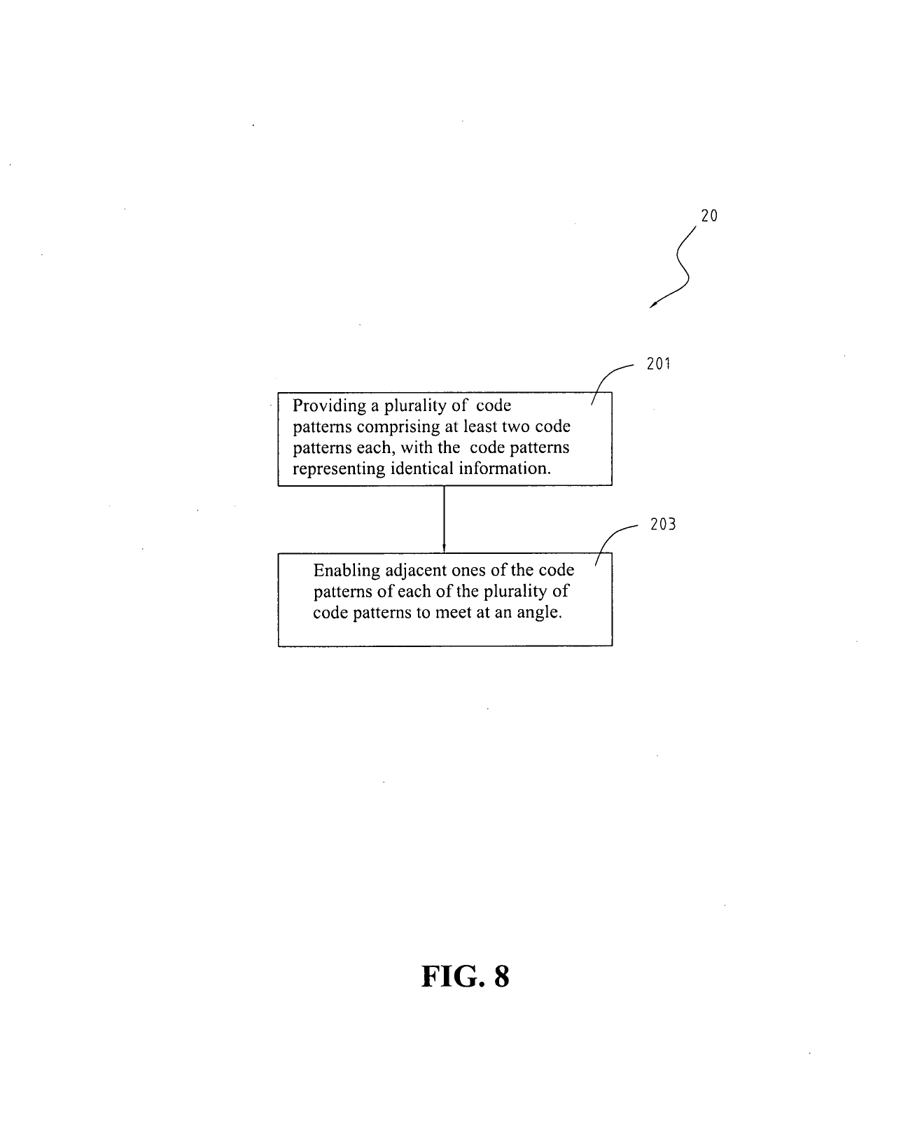

Referring to FIGS. 7, 8 and 9, the present invention provides a method 10 for producing a plurality of code patterns. The method 10 comprises step 101, step 103, and step 105. Step 101 involves providing a first code pattern, a second code pattern, and a third code pattern, wherein the first code pattern, the second code pattern, and the third code pattern represent identical information. Step 103 involves enabling the second code pattern and the first code pattern to meet at an angle, and enabling the third code pattern and the first code pattern to meet at the same angle. Step 105 involves arranging the first code pattern and the second code pattern side by side, and arranging the first code pattern and the third code pattern one above the other.

The present invention further provides a method 20 for producing a plurality of code patterns. The method 20 comprises step 201 and step 203. Step 201 involves providing at least two code patterns each, with the code patterns representing identical information. Step 203 involves enabling adjacent ones of each of the code patterns to meet at an angle.

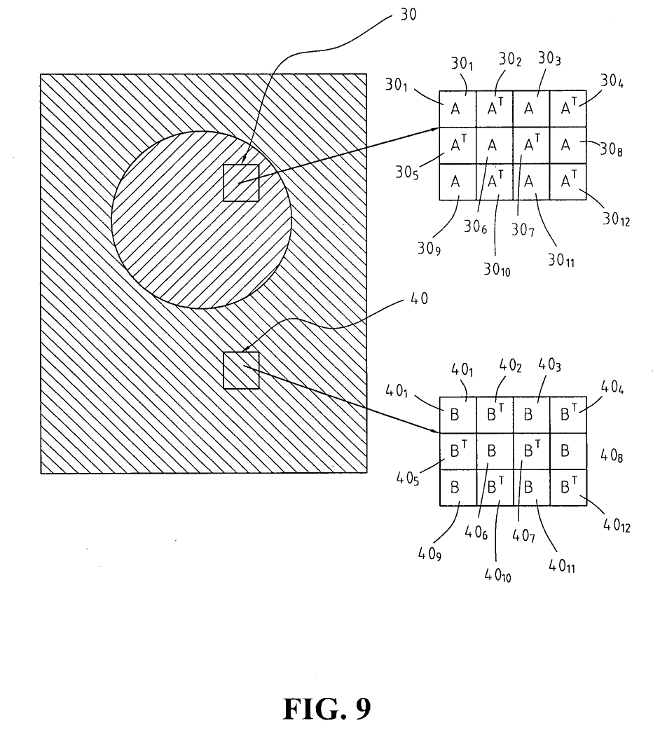

Referring to FIG. 9, a plurality of code patterns 30 comprises code patterns 30₁˜30₁₂, and the code patterns 30₁˜30₁₂ represent identical information, for example, alphabet A. Referring to FIG. 9 again, a plurality of code patterns 40 comprises code patterns 40₁˜40₁₂, and the code patterns 40₁˜40₁₂ represent identical information, for example, alphabet B. In the following example, the code pattern 30₁, the code pattern 30₂, and the code pattern 30₅ of the plurality of code patterns 30 are the first code pattern, the second code pattern, and the third code pattern, respectively. The second code pattern 30₂ and the first code pattern 30₁ meet at an angle. The third code pattern 30₅ and the first code pattern 30₁ meet at the same angle. Referring to FIG. 9 again, in the plurality of code patterns 30, the second code pattern 30₂ is denoted with A^{T} and the first code pattern 30₁ with A, indicating that the second code pattern 30₂ and the first code pattern 30₁ meet at an angle; likewise, the third code pattern 30₅ is denoted with A^{T} and the first code pattern 30₁ with A, indicating that the third code pattern 30₅ and the first code pattern 30₁ meet at the same angle. Referring to FIG. 9 again, in the plurality of code patterns 40, the code patterns denoted with B^{T} and the code patterns denoted with B meet at an angle.

Referring to FIG. 9 again, the first code pattern 30₁ and the second code pattern 30₂ are arranged so as to be side by side, and the first code pattern 30₁ and the third code patterns 30₅ are arranged so as to be one above the other. Hence, from the perspective of the first code pattern 30₁, adjacent the second code pattern 30₂ and the first code pattern 30₁ meet at an angle, whereas adjacent the third code pattern 30₅ and the first code pattern 30₁ meet at an angle. Likewise, from the perspective of the first code pattern 30₆, the first code pattern 30₆ meets adjacent code patterns 30₂, 30₅, 30₇, and 30₁₀ at an angle.

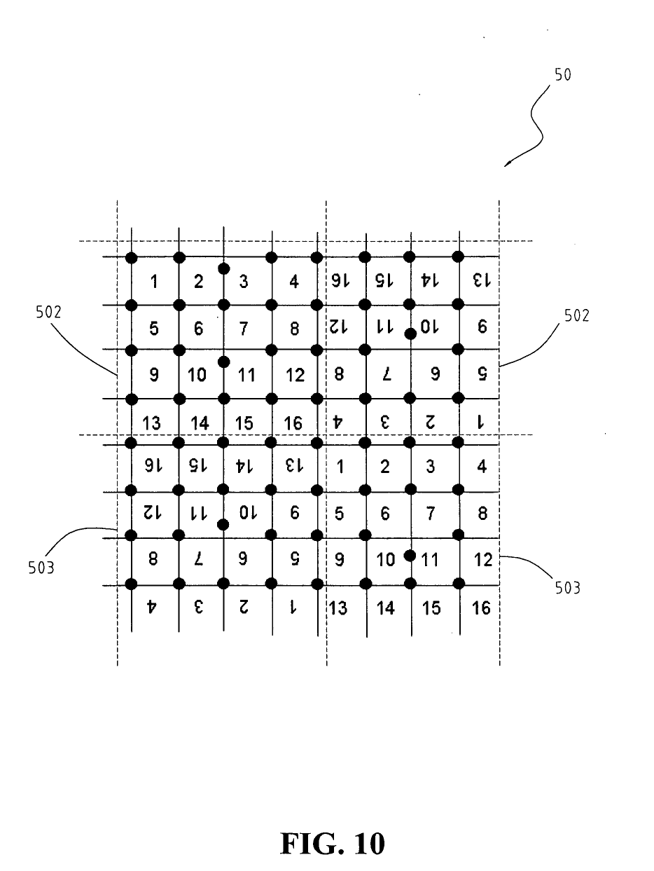

To facilitate description, reference numerals shown in FIG. 10 through FIG. 14 indicate positions of information marks in the code pattern.

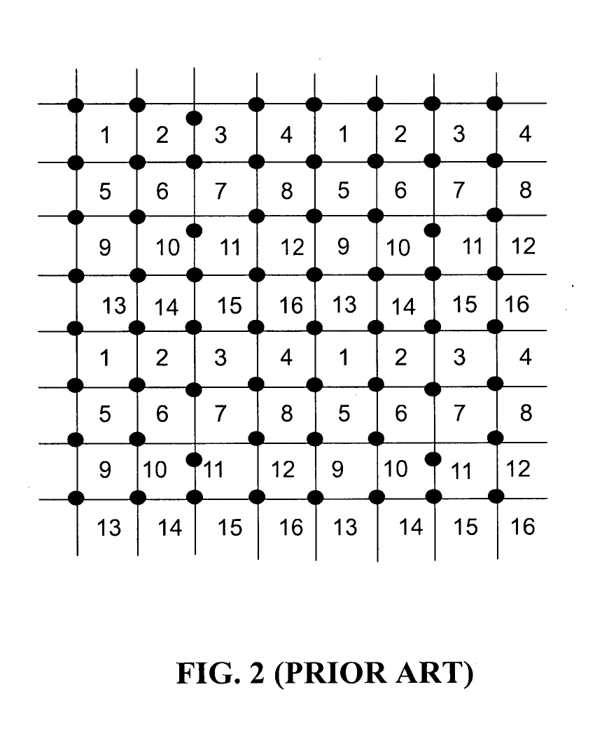

FIG. 10 is a schematic view of an embodiment of the code patterns for use with the producing method of the present invention, compared to FIG. 2 which shows conventional code patterns. Referring to FIG. 2 again, a means of producing the code patterns was disclosed in the Japanese Invention Patent Application Publication No. 2007-11890. Referring to FIG. 10, a plurality of code patterns 50 comprises four code patterns 50₁-50₄, and adjacent the code patterns 50₁-50₄ meet one another at 180 degrees, using the producing method of the present invention. As shown in FIG. 10, if displacement of information marks 1, 2, 3, and 4 is in the same direction, there will not be any conspicuous horizontal stripes, nor will the information marks 1, 2, 3, and 4 be misinterpreted as boundary marks. Furthermore, arrangement of direction marks is more random than related disclosure in Japanese Invention Patent Application Publication No. 2007-11890, so as to reduce visual impact.

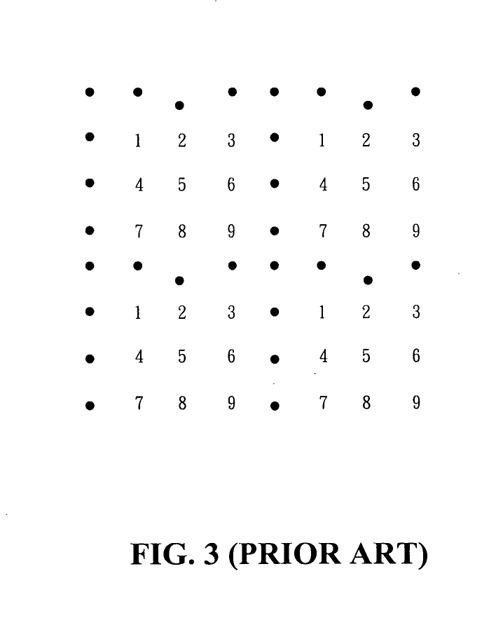

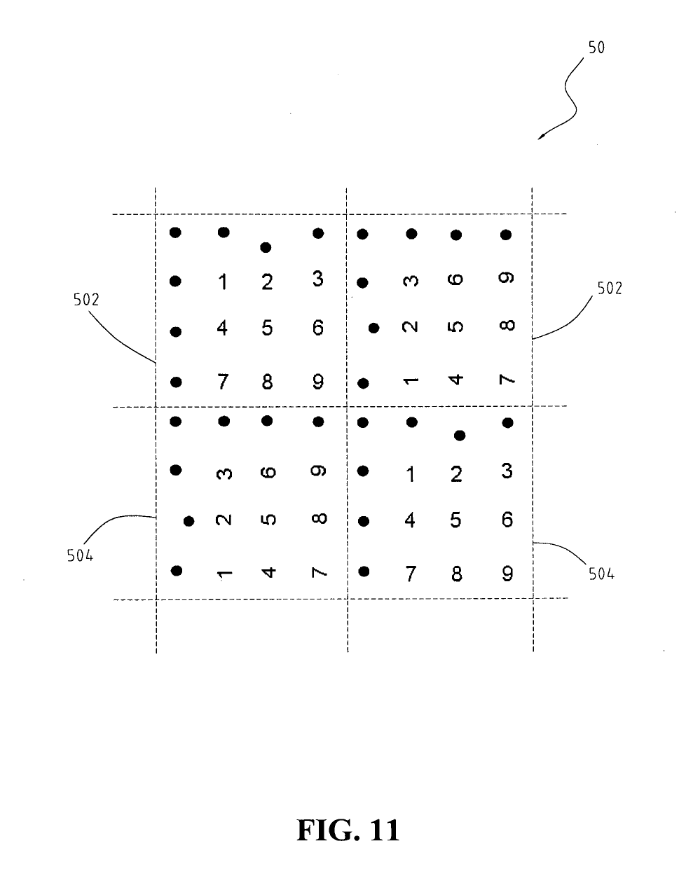

FIG. 11 is a schematic view of an embodiment of the code patterns for use with the producing method of the present invention, compared to FIG. 3 which shows conventional code patterns. Referring to FIG. 3 again, a means of producing the code patterns was disclosed in U.S. Patent Application Publication No. US2007/0246547. Referring to FIG. 11, a plurality of code patterns 50 comprises four code patterns 50₁-50₄, and adjacent the code patterns 50₁-50₄ meet one another at 90 degrees, using the producing method of the present invention. As shown in FIG. 11, vertical and horizontal positioning marks are arranged in a much more random manner, thereby preventing conspicuous vertical and horizontal stripes from occurring to printed matters.

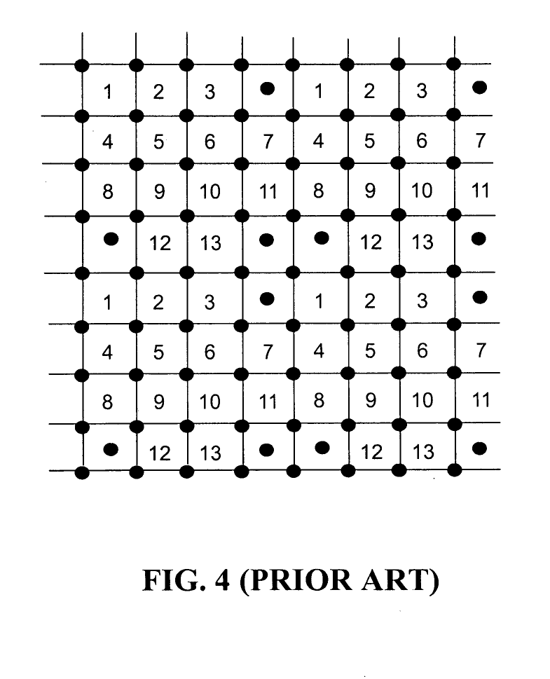

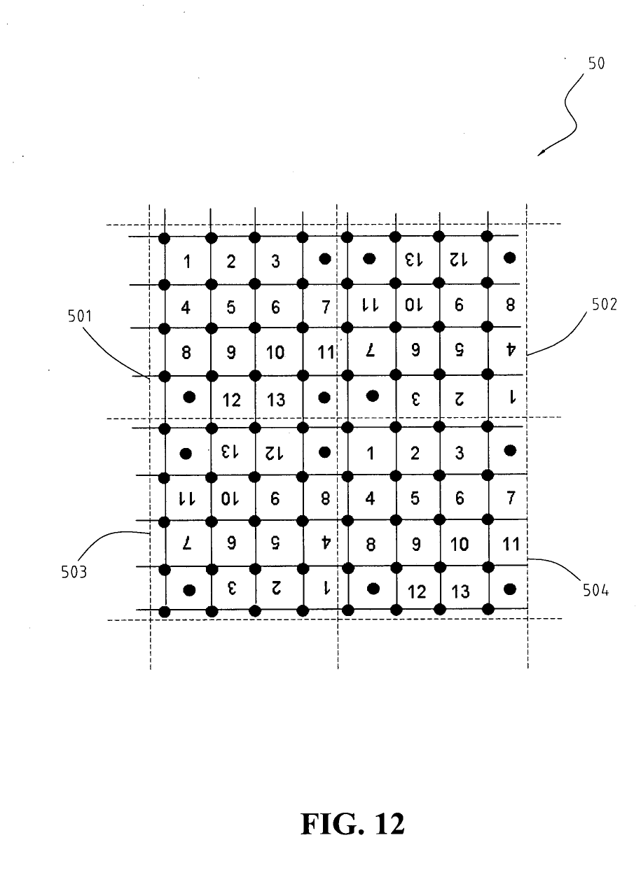

FIG. 12 is a schematic view of an embodiment of the code patterns for use with the producing method of the present invention, compared to FIG. 4 which shows conventional code patterns. Referring to FIG. 4 again, a means of producing the code patterns was disclosed in U.S. Patent Application Publication No. 60/164,8431. Referring to FIG. 12, a plurality of code patterns 50 comprises four code patterns 50₁-50₄, and adjacent the code patterns 50₁-50₄ meet one another at 180 degrees, using the producing method of the present invention. As shown in FIG. 12, if displacement of information marks 4, 5, 6, and 7 is in the same direction, there will not be any conspicuous horizontal stripes, nor will the information marks 4, 5, 6, and 7 be misinterpreted as boundary marks. Furthermore, arrangement of direction marks is more random than related disclosure in U.S. Patent Application Publication No. 60/648,431, so as to reduce visual impact.

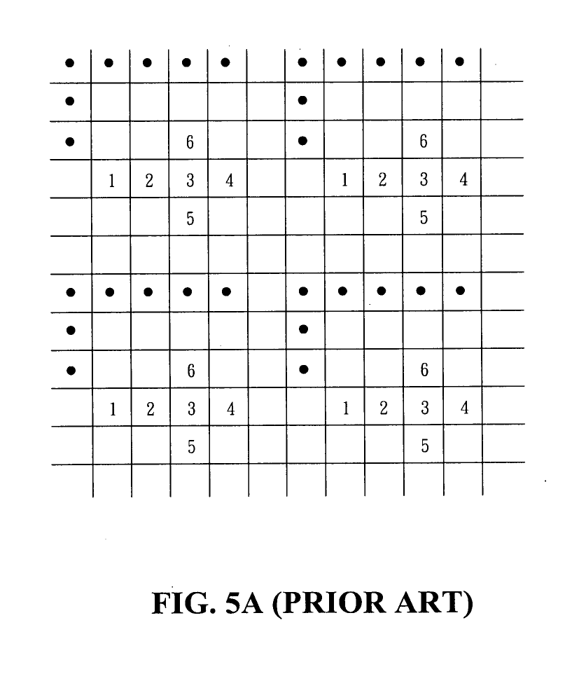

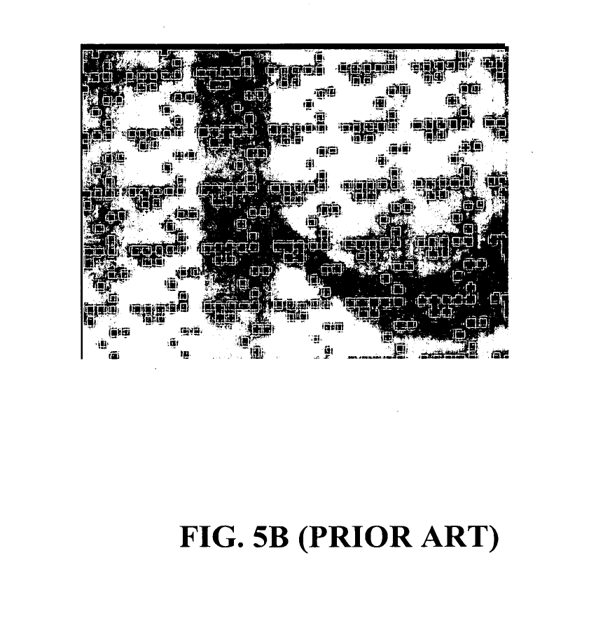

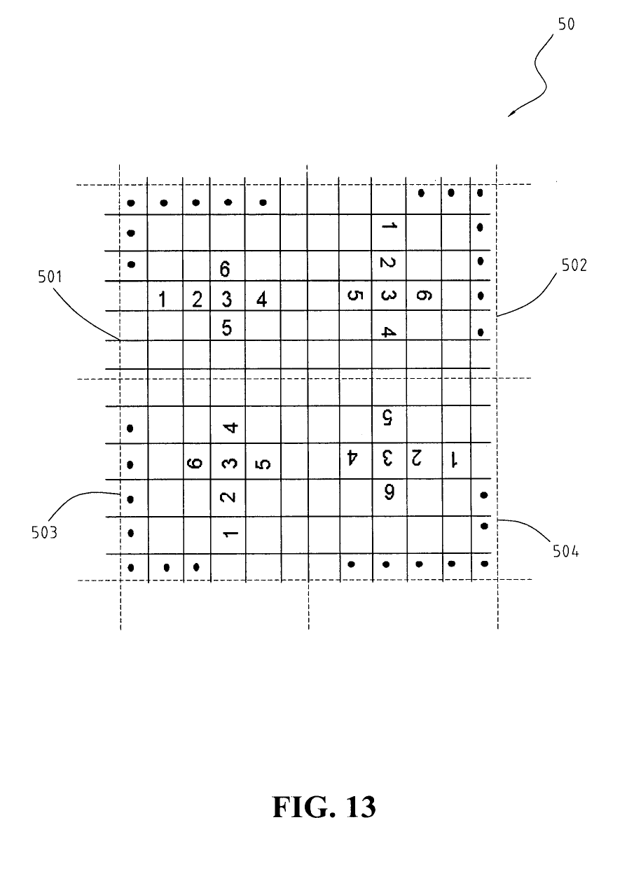

FIG. 13 is a schematic view of an embodiment of the code patterns for use with the producing method of the present invention, compared to FIG. 5A which shows conventional code patterns. Referring to FIG. 5A again, a means of producing the code patterns was disclosed in U.S. Patent Application Publication No. US2003/011164. Referring to FIG. 13, a plurality of code patterns 50 comprises four code patterns 50₁-50₄, and adjacent the code patterns 50₁-50₄ meet one another at 90 degrees, using the producing method of the present invention. As shown in FIG. 13, the plurality of code patterns 50 effectuated by the producing method of the present invention has the following advantages: reduced visual impact; correct orientation of the code patterns at 0 degree, 90 degrees, 180 degrees, and 270 degrees; and measurement of the range of rotation is not required.

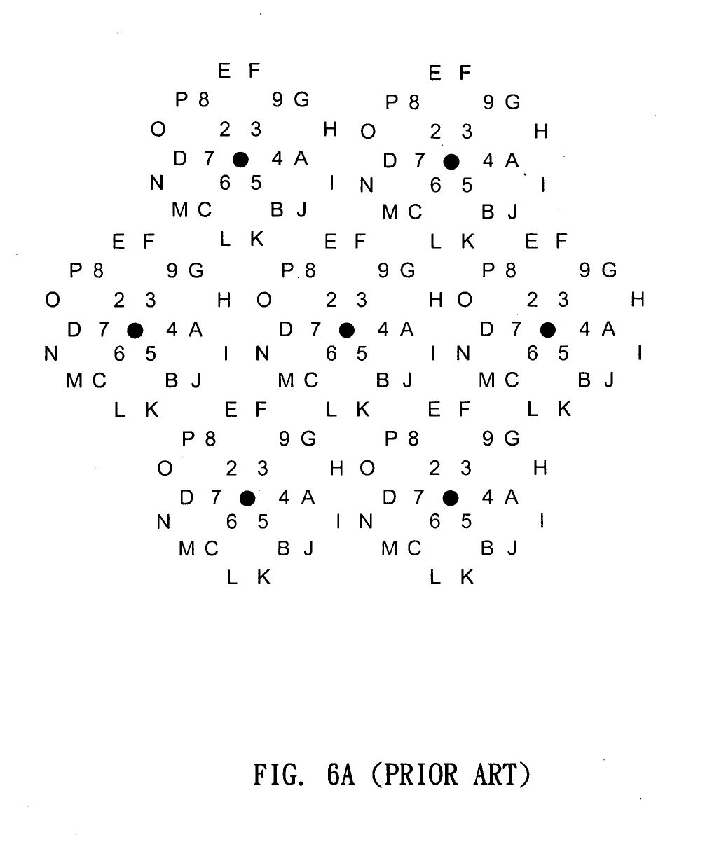

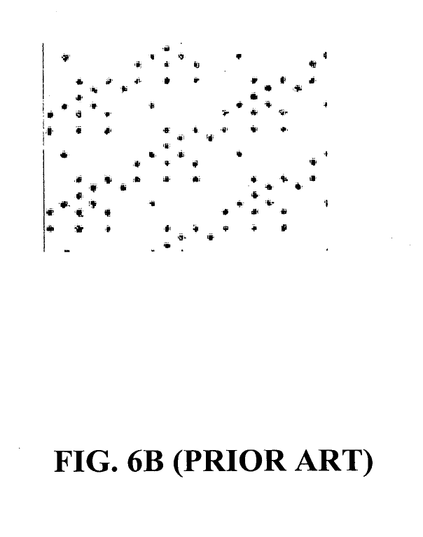

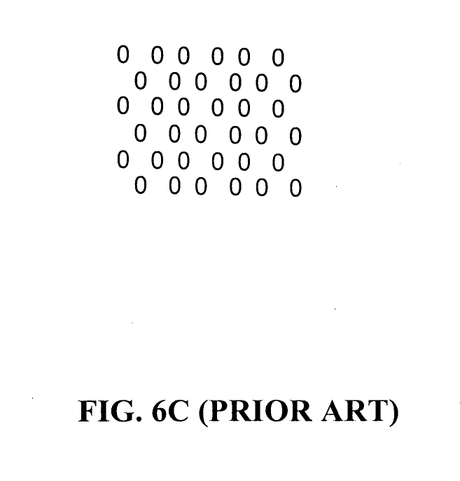

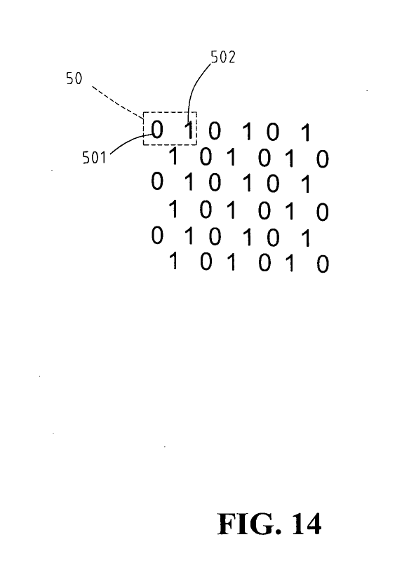

FIG. 14 is a schematic view of an embodiment of the code patterns for use with the producing method of the present invention, compared to FIG. 6A which shows conventional code patterns. Referring to FIG. 6A again, a means of producing the code patterns was disclosed in U.S. Patent Application Publication No. US2006/0007255. FIG. 6C illustrates an embodiment of the code patterns shown in FIG. 6A. Referring to FIG. 14 and FIG. 6C, the range of rotation of the code patterns denoted with “0” is 0 degree, and the range of rotation of the code patterns denoted with “1” is 180 degrees. Referring to FIG. 14, a plurality of code patterns 50 comprises two code patterns 50₁ and 50₂, and adjacent the code patterns 50₁ and 50₂ meet one another at 180 degrees, using the producing method of the present invention. As shown in FIG. 14, the plurality of code patterns 50 effectuated by the producing method of the present invention has the following advantages: reduced visual impact; at most two repeated code patterns at 45 degrees only; and no two or more repeated code patterns in the horizontal direction. The plurality of code patterns 50 of the present invention has less visual impact than US2006/0007255, because the code patterns of the plurality of code patterns 50 are not contiguous horizontally or vertically, though vertically.

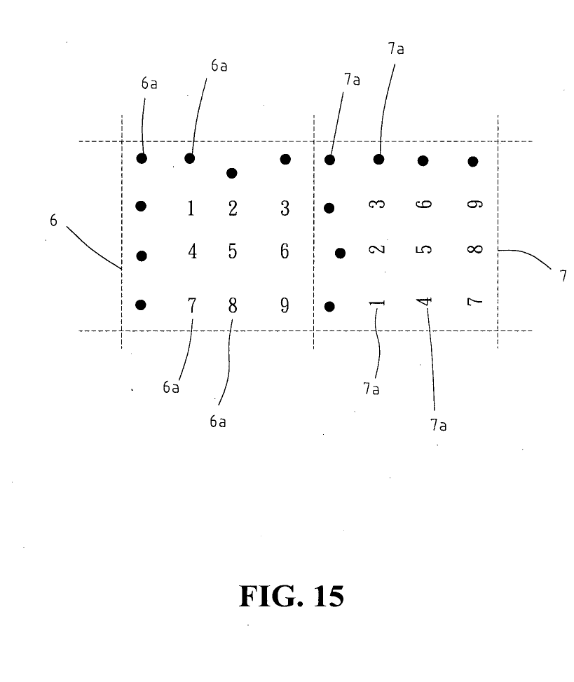

Referring to FIGS. 15 through 17, in addition to the aforesaid technical features of the method 10 for producing a plurality of code patterns, the present invention further provides three means of producing all the first marks 6a and all the second marks 7a of a first code pattern 6 and a second code pattern 7, respectively, which represent identical information. To facilitate description, reference numerals shown in FIG. 15 through FIG. 17 indicate positions of information marks in the first and second code patterns 6 and 7.

Referring to FIG. 15, a configuration of all the second marks 7a of the second code pattern 7 is acquired by 90 degrees anticlockwise rotation of a configuration all the first marks 6a of the first code pattern 6. Hence, an included angle of 90 degrees is formed between a configuration all the first marks 6a of the first code pattern 6 and a configuration of all the second marks 7a of the second code pattern 7. Afterward, the first code pattern 6 and the second code pattern 7 adjoin.

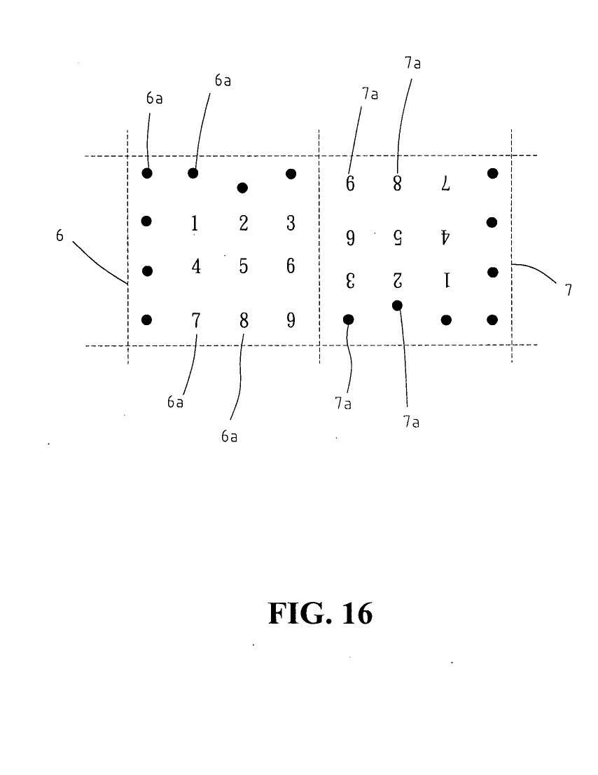

Referring to FIG. 16, a configuration of all the second marks 7a of the second code pattern 7 is acquired by 180 degrees anticlockwise rotation of a configuration all the first marks 6a of the first code pattern 6. Hence, an included angle of 180 degrees is formed between a configuration all the first marks 6a of the first code pattern 6 and a configuration of all the second marks 7a of the second code pattern 7. Afterward, the first code pattern 6 and the second code pattern 7 adjoin.

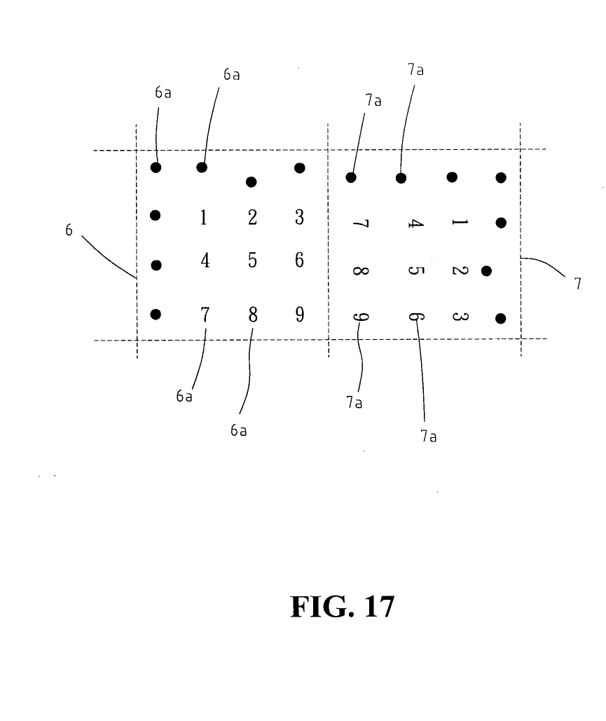

Referring to FIG. 17, a configuration of all the second marks 7a of the second code pattern 7 is acquired by 270 degrees anticlockwise rotation of a configuration all the first marks 6a of the first code pattern 6. Hence, an included angle of 270 degrees is formed between a configuration all the first marks 6a of the first code pattern 6 and a configuration of all the second marks 7a of the second code pattern 7. Afterward, the first code pattern 6 and the second code pattern 7 adjoin.

The plurality of code patterns implemented by the producing method of the present invention feature reduced visual impact, which accounts for the inventiveness of the present invention.

The foregoing descriptions refer to merely the preferred embodiments of the present invention and are not intended to restrict the scope of the present invention. The various changes and modifications apparent thereto may be effected by those skilled in the art without departing from the scope of the invention as defined by the appended claims.

What is claimed is:

1. A method for producing a plurality of code patterns, comprising the steps of:
providing a first code pattern, a second code pattern, and a third code pattern, wherein the first code pattern, the second code pattern, and the third code pattern represent identical information;
enabling the second code pattern and the first code pattern to meet at an angle, and enabling the third code pattern and the first code pattern to meet at the angle; and
arranging the first code pattern and the second code pattern side by side, and
arranging the first code pattern and the third code pattern one above the other.

2. A method for producing a plurality of code patterns, comprising the steps of:
providing a plurality of code patterns comprising at least two code patterns each, the code patterns representing identical information; and
enabling adjacent ones of the code patterns of each of the code patterns to meet at an angle.

3. The method for producing a plurality of code patterns of claim 2, wherein the adjacent ones of the code patterns are side by side.

4. The method for producing a plurality of code patterns of claim 2, wherein the adjacent ones of the code patterns are one above the other.

5. A plurality of code patterns comprising: at least two code patterns each, the code patterns representing identical information and characterized in that adjacent ones of each of the code patterns meet at an angle.

6. The plurality of code patterns of claim 5, wherein the adjacent ones of the code patterns are side by side.

7. The plurality of code patterns of claim 5, wherein the adjacent ones of the code patterns are one above the other.

8. A plurality of code patterns, comprising:
a first code pattern representing information and comprising a plurality of first marks; and
a second code pattern comprising a plurality of second marks and being adjacent to the first code pattern; wherein the first and second code patterns represent identical information;
wherein an included angle of one of 90 degrees, 180 degrees, and 270 degrees is formed between a configuration of the second marks and a configuration of the first marks.
